(19) United States
(12) Patent Application Publication
(10) Pub. No.: US 2011/0095141 A1
(43) Pub. Date: Apr. 28, 2011

(54) Auxiliary Fixture for Installation of Wall-Mounted Sanitary Fitting

(76) Inventor: Yu-Yu HSIEH, Hemei Township (TW)

(21) Appl. No.: 12/243,510

(22) Filed: Oct. 1, 2008

(51) Int. Cl. F16L 3/08; F16M 13/02

(52) U.S. Cl. 248/73; 248/222.14

(57) ABSTRACT

The present invention pertains to an auxiliary fixture for installation of wall-mounted sanitary fitting including a fitting body that has an upright supporting block for allowing a supporting bolt to penetrate, so that the supporting bolt can reserve an appropriate length for adjustably screwing in and retracting to stretch a spreading blocking member to propel against a back template. Therefore, while assembling cold-hot water and upper-lower feed and outlet pipes to the fitting body, the length reservation of the supporting bolt assists in firmly directing the spreading blocking member against the template and positioning the fitting body, hence improving installing efficiency, the accuracy of positioning, and the convenience when installing the fitting body.

### BACKGROUND OF THE INVENTION

1. Field of the Invention

The present invention relates to a faucet structure, in particular to an auxiliary fixture for installation of wall-mounted sanitary fitting for increasing the operating speed, accuracy, and convenience.

2. Description of the Related Art

Typically, constructors initially frame walls and set up templates for embedding a fitting body (without a controlling handle) into the wall and proceeding the distribution of pipelines. Thereafter, the fitting body can be fixed at a predetermined position after grouting cement contents into the wall. In this manner, the appearance of the fitting body can be hidden and the room for placing the fitting body can be decreased. Moreover, after grouting and hardened, the fitting body will not depart from walls or templates and avoid the deviation of the installation angle.

However, the conventional operation of installing the fitting body along with additional articles between the templates requires much time and work and users hardly control the appropriate fitting position by means of the poor fastness of the installation of the fitting body caused by the pressure and the weight while grouting or other variations. Therefore, it may cause the fitting body slantingly adhering to the wall after the concrete cement is dried and hardened, which however results in the inconvenience of restoring and adjusting the slanting faucet because of the hardened concrete.

Therefore, a Taiwan Utility Model Application No. 93217981 relates to a structure of inner-wall water supply controlling valve (shown in FIGS. 1 and 2) mainly comprising a faucet 2, a screw slot 21, a supporting bolt 22, a blocking member 23, and a back template R2. Wherein, the screw slot 21 protrudes backward from the lateral of the faucet 2 so as to fit with the supporting bolt 22, whose length is preset according to the wall thickness, and allow the bolt 22 to adjustably screw into the wall, for simultaneously propelling the blocking member 23 backward. Therefore, an inner side of the back template R2 is propped with the blocking member 23, and the faucet 2 is thus orientated at the desired position. In this manner, when in the process of constructing a feed pipe of cold-hot water, an upper-lower outlet pipe, and other pipes in the faucet 2, the faucet 2 will not sway or displace.

However, the truncations of the supporting bolt 22 for presetting its length may incur the inconvenience for constructors to arrange workpieces. In addition, the faucet 2 has the screw slot 21 protruded backward from its lateral side and the supporting bolt 22 positioned at its rear side, which not only occupies a large space but causes the inconvenience for constructors to impart the force on the faucet 2 in time of adjusting.

### SUMMARY OF THE INVENTION

One object of the present invention is to provide an auxiliary fixture for installation of wall-mounted sanitary fitting for improving installing efficiency, the accuracy of positioning, and the convenience when installing the fitting body.

Another object of the present invention is to provide a supporting bolt disposed in an upright supporting block that protrudes from an intermediate section of a fitting body. Wherein, the length of the supporting bolt is set according to the entire thickness of the fitting body for adjustably placing the supporting bolt, which thus reducing the dimension of the fitting body and simplifying the process of operation and arrangement of workpieces to achieve the economic benefits.

Another object of the present invention is to provide the supporting bolt disposed in the upright supporting block that protrudes from the intermediate section of the fitting body. Wherein, the supporting bolt can cooperate with various walls, so that the present invention benefits of extensively applying the structure on various walls to achieve the practicability.

The auxiliary fixture for installation of wall-mounted sanitary fitting in accordance with the present invention mainly provides with the fitting body having the upright supporting block protruding from the intermediate section thereof and the screw slot longitudinally defined on the upright supporting block for allowing the supporting bolt without proceeding truncations to penetrate therethrough. The supporting bolt thus can be adjustably screwed in and retracted to provide a suitable length for driving a spreading blocking member located in the rear area of the bolt to be propped against an inner side of a back template. Then a feed pipe for cold-hot water and an upper-lower outlet can be distributively installed to the fitting body. Thus, the spreading blocking member can be adjustably propped against the back template in advance for firmly position the fitting body by the assistance of the length reservation of the supporting bolt, which hence increases the installing speed and enhances the operation accuracy.

The advantages of the present invention over the known prior arts will become more apparent to those of ordinary skilled in the art by reading the following descriptions with relating drawings.

### BRIEF DESCRIPTION OF THE DRAWINGS

FIG. 1 is a perspective view showing a conventional invention;

FIG. 2 is a schematic view showing the installation of the conventional invention;

FIG. 3 is a perspective view showing the present invention;

FIG. 4 is a schematic view showing the installation of the present invention;

FIG. 5-A is a first cross-sectional view showing the present invention before grouting;

FIG. 5-B is a second cross-sectional view showing the present invention before grouting;

FIG. 5-C is a cross-sectional view showing the present invention after grouting;

FIG. 6-A is a schematic view showing a second embodiment of the present invention;

FIG. 6-B is a cross-sectional view showing the second embodiment after grouting;

FIG. 7-A is a schematic view showing a third embodiment of the present invention;

FIG. 7-B is a cross-sectional view showing the third embodiment before grouting; and

FIG. 7-C is a cross-sectional view showing the third embodiment after grouting.

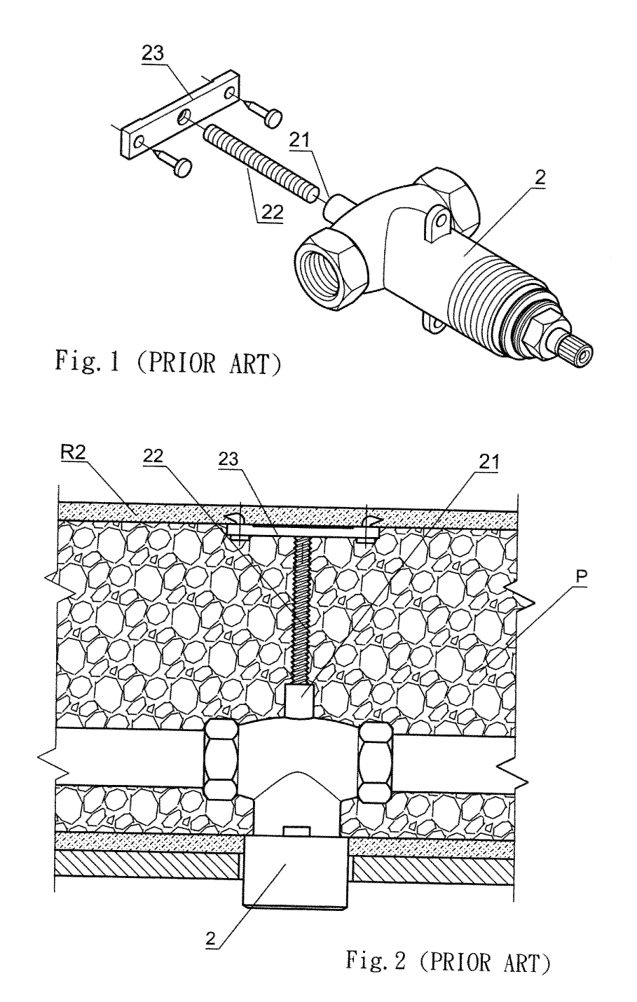

### DETAILED DESCRIPTION OF THE PREFERRED EMBODIMENTS

Before describing in greater detail, it should note that the like elements are denoted by the similar reference numerals throughout the disclosure.

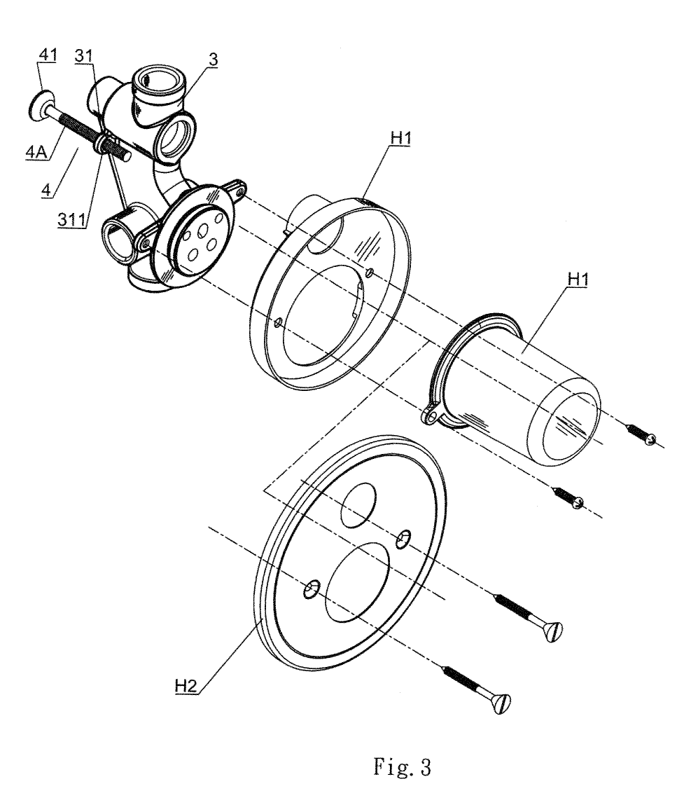

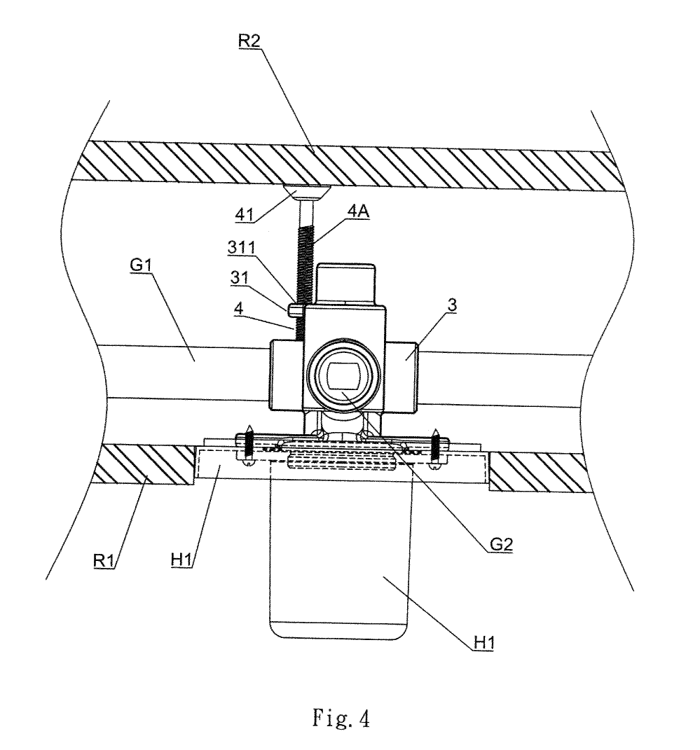

Referring to FIGS. 3 and 4, the auxiliary fixture for installation of wall-mounted sanitary fitting of the present invention mainly provides with a fitting body 3; wherein, an upright supporting block 31 protrudes from an intermediate section of a fitting body 3 and has a screw slot 311 longitudinally disposed thereon. Further, a supporting bolt 4, which penetrates through the screw slot 311, has a plurality of outer threads 4A disposed thereon and a spreading blocking member 41 disposed on the rear area thereof so that the supporting bolt 4 can be screwed and retracted longitudinally for adjusting its protruding length and the screwing location.

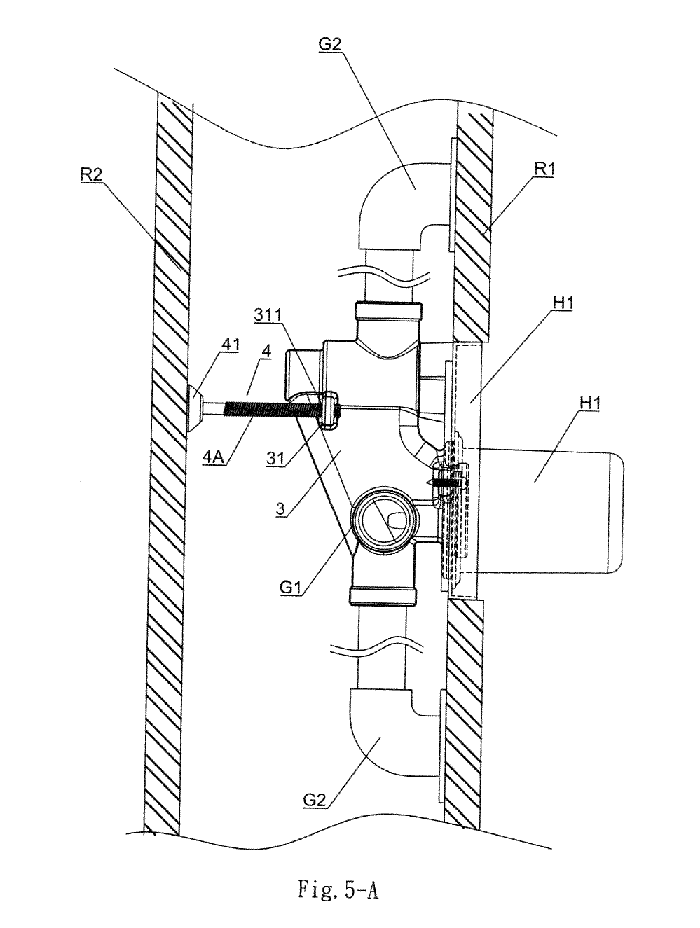

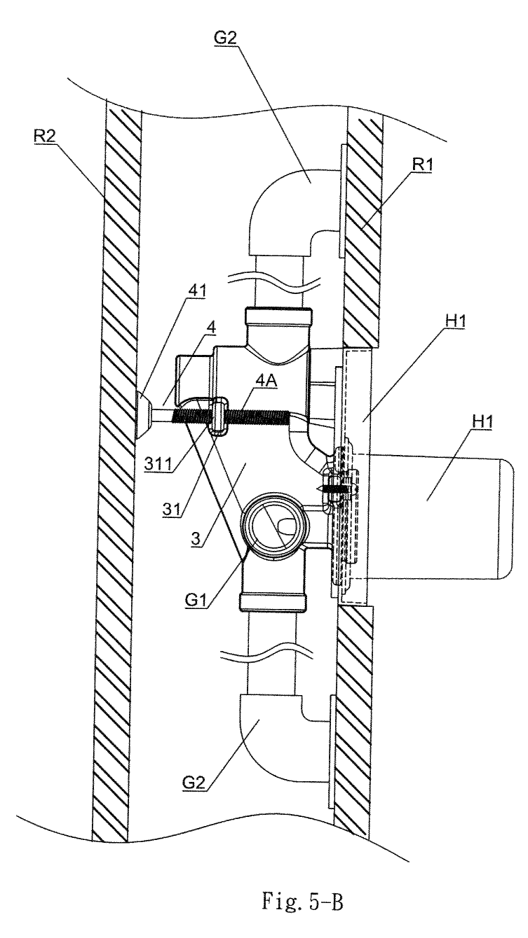

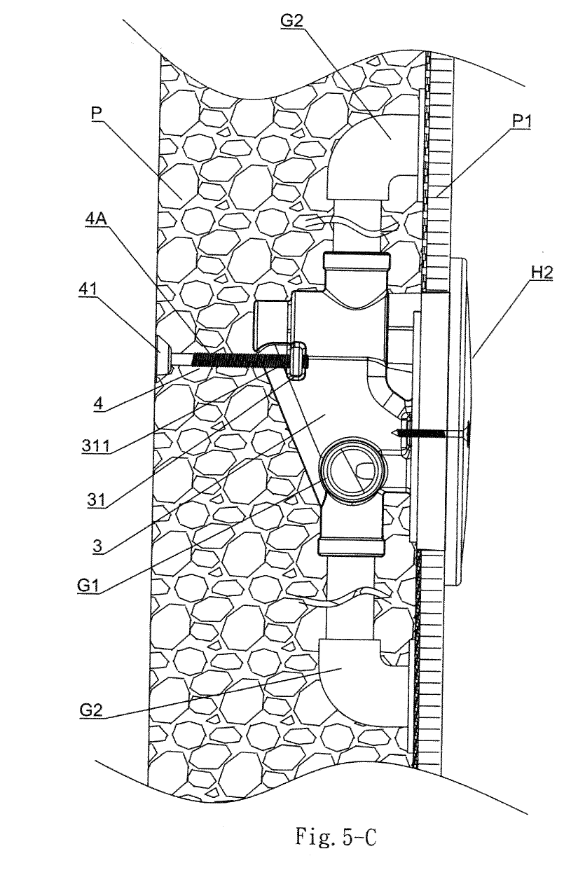

In particular, the protruding length of the supporting bolt 4 can be preset base on the distance between a front template R1 and a back template R2 and additionally reserved a length measured at least half of the thickness of the entire fitting body 3, so that the supporting bolt 4 has enough space to be screwed forwards or retracted backward, whereby the spreading blocking member 41 in the rear area of the supporting bolt 4 can be adjustably propelled via the supporting bolt 4 for densely propping against the back template R2, which thus reserves an appropriate length for fixing the entire fitting body 3 in the wall and increases the constructing scope of the wall to facilitate the extensive applicability of the present invention as shown in FIGS. 5-A and 5-B.

Further referring to FIGS. 4, 5-A and 5-B, when in the process of constructing a feed pipe of cold-hot water G1, an upper-lower outlet pipe G2, and other pipes in the fitting body 3, the fitting body 3 would not shake or displace due to that the supporting bolt 41 is estimated at an appropriate length to make the spreading blocking member 41 to be firmly propped against the back template R2 for assisting in initially positioning the fitting body 3 at the predetermined place. Therefore, the structure conduces to conveniently arrange the distribution of the pipes and benefits of achieving the accuracy and the rapid installation by speedily identifying the desired position.

Still, before or while distributing the feed pipe G1 and outlet pipe G2, constructors can manually adjust the protruding length of the supporting bolt 4 to reduce the possibility of the distance errors occurred while assembling the fitting body 3 between the front and the back templates R1, R2.

Referring to FIG. 5C, after mounting the feed pipe G1 and the outlet pipe G2 to the fitting body 3, the fitting body 3 has a mudguard H1 disposed in the front thereof for protecting the bolt or other components protruded out of the body 3. Further, a certain amount of cement mortar grouting into the area between the front template R1 and the back template R2 is dried and hardened to become a concrete wall P, and a surface layer P1, for instance of a tile, is hence formed after dismantling the two templates R1,R2. Then the mudguard H1 can be dismantled and replaced by a front lateral cover board H2 to firmly and readily fix the fitting body 3 into the wall P. Further, by means of concatenation of the supporting bolt 4, the feed pipe G1, and the outlet pipe G2, the fitting body 3 are thus stably fixed and disposed between the templates R1, R2 so as to bear the pressure and gravity while grouting and allow the fitting body 2 to be positioned at the desired place after the concrete wall P is hardened, thus increasing the constructing convenience and enhancing the installing accuracy.

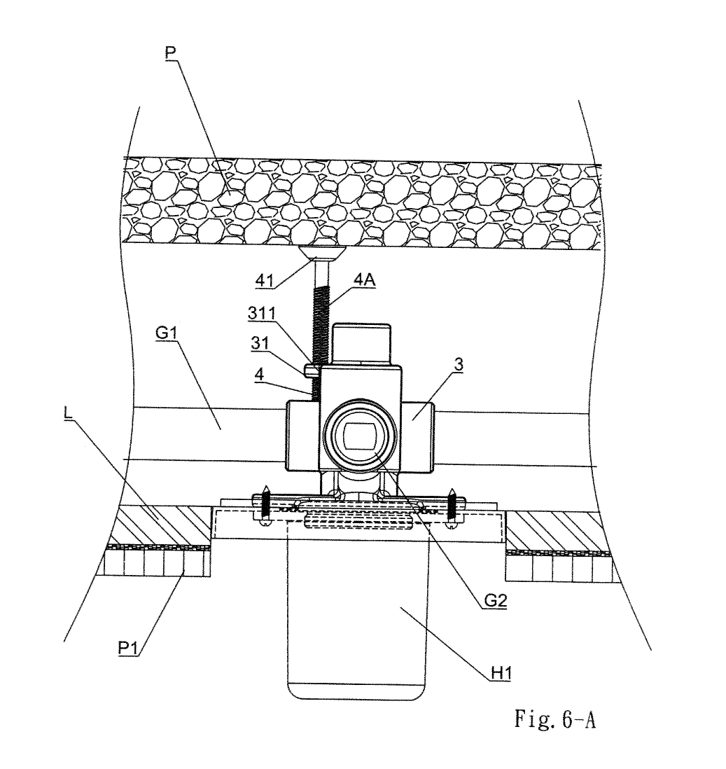

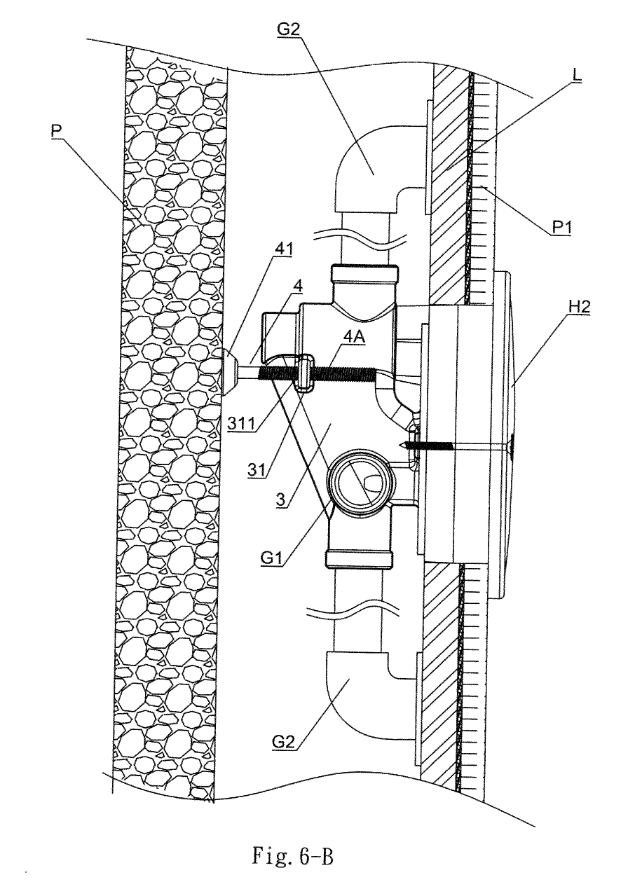

Furthermore referring to FIGS. 6-A and 6-B, the second preferred embodiment of the present invention can also be applied to various walls without grouting cement mortar, namely applying on a already-finished concrete wall P or other walls and accompanying the feed pipe G1 and the outlet pipe G2 to be installed to the fitting body 3. By means of the supporting bolt 4 performed in a proper length, the spreading blocking member 41 thus can be directly against the concrete wall P or other walls, and the fitting body 3 can be preliminarily installed at the desired position after assembling a repairing plank L (or a surface layer P1) on the front side of the body 3, so that the fitting body 3 does not slip easily. Therefore, the present invention precisely reserves the operating space within walls and achieves the convenience of operation.

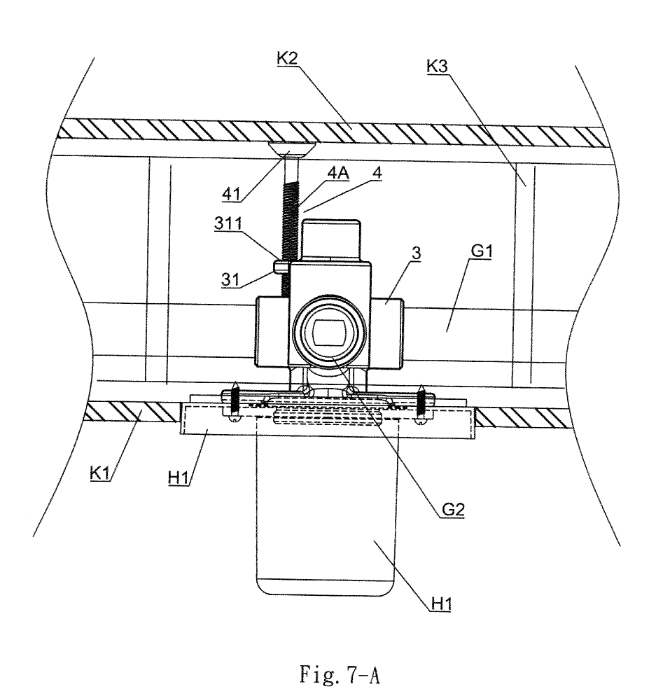

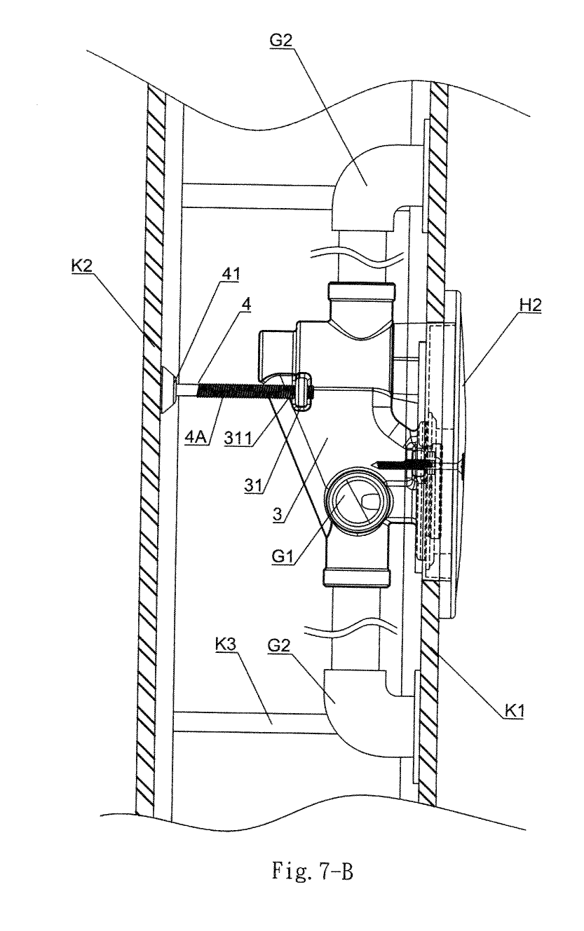

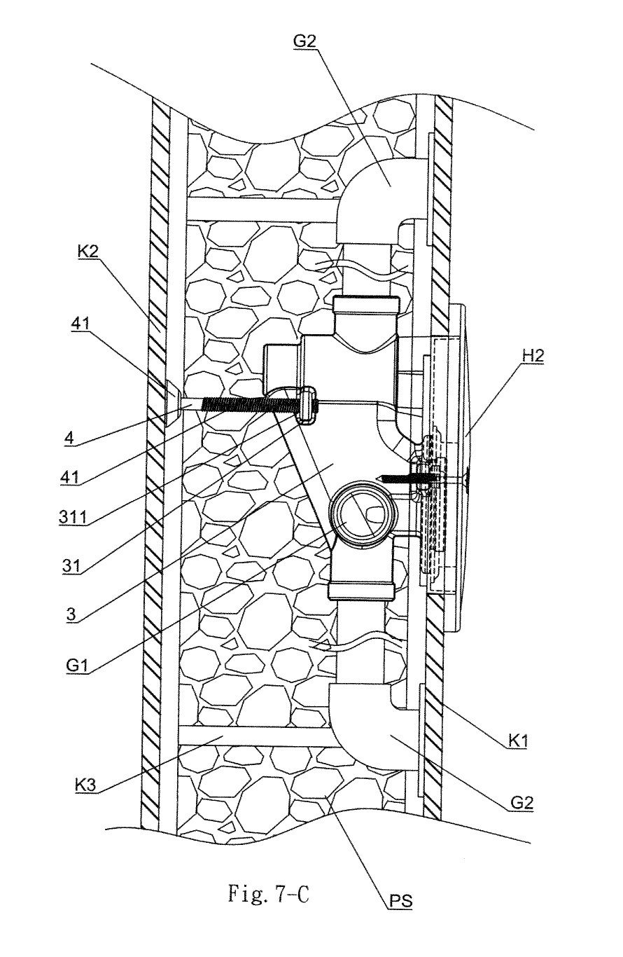

Further referring to FIGS. 7-A and 7-B, the third preferred embodiment of the present invention can be applied to the wall formed by a front wallboard K1 and a back wallboard K2 (surface layers can be increased on their outsides) with light frameworks K3 supporting and connecting the inner sides of the wallboards K1, K2. By means of the supporting bolt 4 performed in a proper length, the spreading blocking member 41 thus can be directly against the front side of the back wallboard K2, and the fitting body 3 can be preliminarily installed at the desired position after assembling the front wallboard K1 on the front side of the body 3, so that the fitting body 3 does not slip easily. Therefore, the present invention obtains the benefit of precisely reserving the space within walls base on the thickness of the frameworks K3.

Further referring to FIG. 7-C, while applying the wall formed by the front wallboard K1 and the back wallboard K2 along with the light frameworks K3 supporting and connecting the inner sides of the wallboards K1, K2 and accomplishing the installation of the feed pipe G1 and the outlet pipe G2 in the fitting body 3, the present invention can also grout the cement mortar between the two wallboards K1, K2 to form in a light concrete wall PS with higher strength. Further accompanies with the supporting bolt 4 to be firmly propped against the two wallboards K1, K2, the present invention hence can achieve the same effect as the previous preferred embodiments.

To sum up, the present invention takes advantages of a supporting bolt penetrating through an upright supporting block that protrudes from a fitting body, and the bolt can be adjustable set at a proper length without truncating and also reserve enough length for screwing and retracting and controlling the movements of the spreading blocking member, thereby enhancing an accurate placement of the fitting body and providing convenience of operation. The present invention can be also applied on a variety of walls, such as templates, concrete walls, or wallboards to achieve the extensive applicability.

While we have shown and described the embodiment in accordance with the present invention, it should be clear to those skilled in the art that further embodiments may be made without departing from the scope of the present invention.

I claim:

1. An auxiliary fixture for installation of wall-mounted sanitary fitting comprising:
a fitting body which having an upright supporting block with a screw slot longitudinally defined on the upright supporting block.
a supporting bolt penetrating through the screw slot having a plurality of outer threads provide a reserved length for allowing the supporting bolt to have enough space to be screwed forward and retracted backward.

2. The auxiliary fixture as claimed in claim 1, wherein a protruding length of the supporting bolt is preset basing on a distance between the front template, the repairing plank, or the wallboard and the back template, the concrete wall, or the wallboard, which further additionally reserves a length measured at least half of the thickness of the fitting body; whereby the supporting bolt has enough length to adjustably stretch the spreading blocking member backward for propping against the back template so as to position the fitting body.

3. The auxiliary fixture as claimed in claim 1, wherein the supporting block protruding from an intermediate section of fitting body.

4. The auxiliary fixture as claimed in claim 1, wherein a supporting bolt having a spreading blocking members wherein, the spreading blocking member firmly propping against a back template, a concrete wall, or a wallboard via the supporting bolt while proceeding distributions of a feed pipe for cold-hot water and an upper-lower outlet pipe processed in the fitting body, and the fitting body can be positioned in a front template, a repairing plank, or another wallboard at a desired place in advance to avoid a displacement of the fitting body while being subjected to a pressure in time of grouting.
